(19) United States
(12) Patent Application Publication
(10) Pub. No.: US 2009/0172953 A1
(43) Pub. Date: Jul. 9, 2009

(54) CUTTING DEVICE FOR CUTTING BARREL

(75) Inventor: CHENG-SHIUN WU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/198,277

(22) Filed: Aug. 26, 2008

(30) Foreign Application Priority Data
Jan. 9, 2008 (CN) 200810300052.5

(51) Int. Cl. B26B 13/00

(52) U.S. Cl. 30/173

(57) ABSTRACT

An exemplary cutting device includes a first main body and a second main body pivotally mounted on the first main body. The first main body includes a cutting portion arranged at one end thereof. The cutting portion includes two spaced blades disposed at one end thereof. Each blade has a cutting edge. The second main body includes a supporting portion, and the supporting portion faces the cutting edges of the blades. The supporting portion is movable in a direction towards the blades or away from the blades.

### BACKGROUND

1. Technical Field

The present invention relates to a cutting device, and particularly, to a cutting device for cutting a barrel of a lens module.

2. Description of Related Art

Generally, a lens module includes a barrel and a plurality of optical elements (e.g., lenses, and infrared-cut filters) received in the barrel. In assembly, the optical elements are assembled into the barrel. When imaging quality of the lens module fails to reach a set standard, some optical elements are removed so as to be recycled. A typical method for removing the optical elements includes the steps of: holding the barrel using one hand of an operator; cutting the barrel with an ordinary knife using another hand of the operator; and taking the to-be-recycled optical elements out of the barrel.

However, the to-be-recycled optical element may be easily damaged and the operator may be easily injured by the knife when performing the above method. Furthermore, it is troublesome to recycle the optical elements, thus increasing cost of recycling the optical elements.

Therefore, a new cutting device is desired to overcome the above mentioned problems.

### SUMMARY

An exemplary cutting device includes a first main body and a second main body pivotally mounted on the first main body. The first main body includes a cutting portion arranged at one end thereof. The cutting portion includes two spaced blades disposed at one end thereof. Each blade has a cutting edge. The second main body includes a supporting portion, and the supporting portion faces the cutting edges of the blades. The supporting portion is movable in a direction towards the blades or away from the blades.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, perspective view of a to-be-cut lens module, according to an exemplary embodiment.

FIG. 2 is a schematic, isometric exploded view of a cutting device for cutting a barrel of the lens module of FIG. 1, according to an exemplaryembodiment.

FIG. 3 is another schematic, isometric view of a first main body of the cutting device of FIG. 2.

FIGS. 4-6 are schematic, perspective views showing how the barrel is cut using the cutting device of FIG. 2.

FIG. 7 is a schematic, perspective view of the lens module of FIG. 1 after part of a barrel has been cut off.

### DETAILED DESCRIPTION OF THE EMBODIMENTS

Embodiments will now be described in detail below with reference to the drawings.

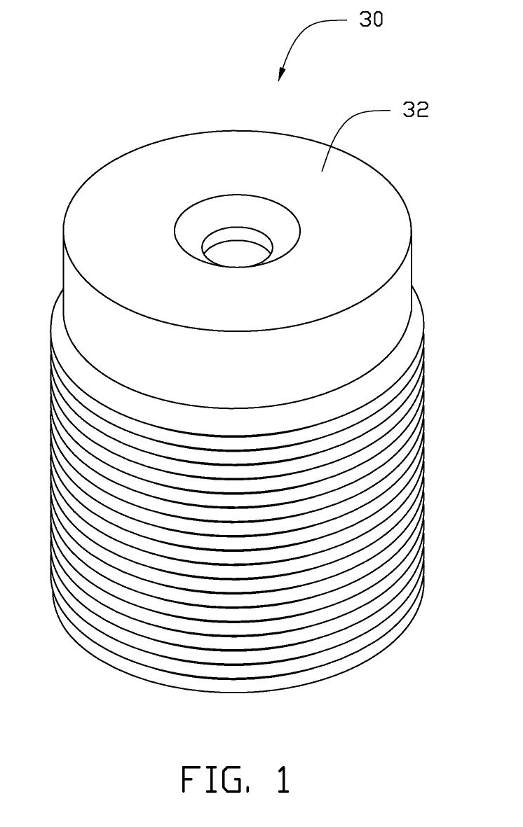

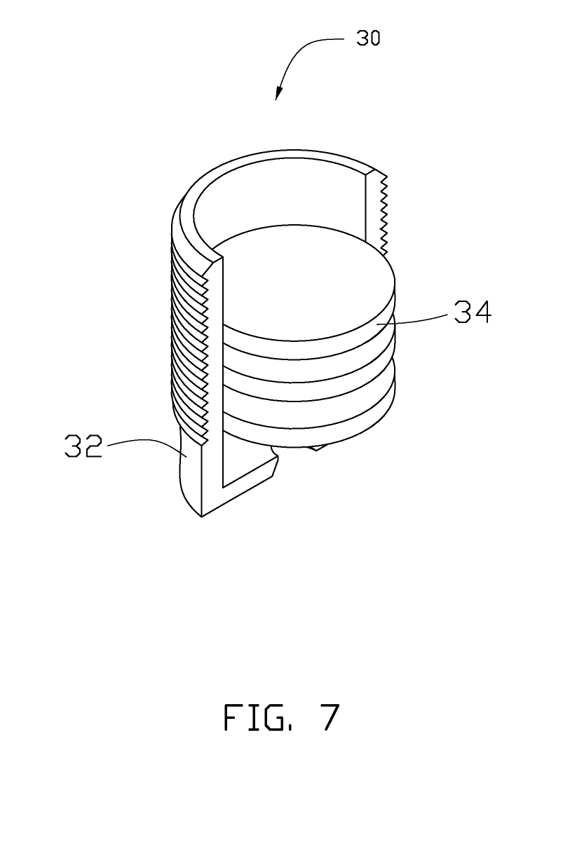

Referring to FIG. 1 and FIG. 7, a lens module 30 includes a barrel 32 and a plurality of optical components 34 received in the barrel 32, for example, lenses, spacers, and optical filters.

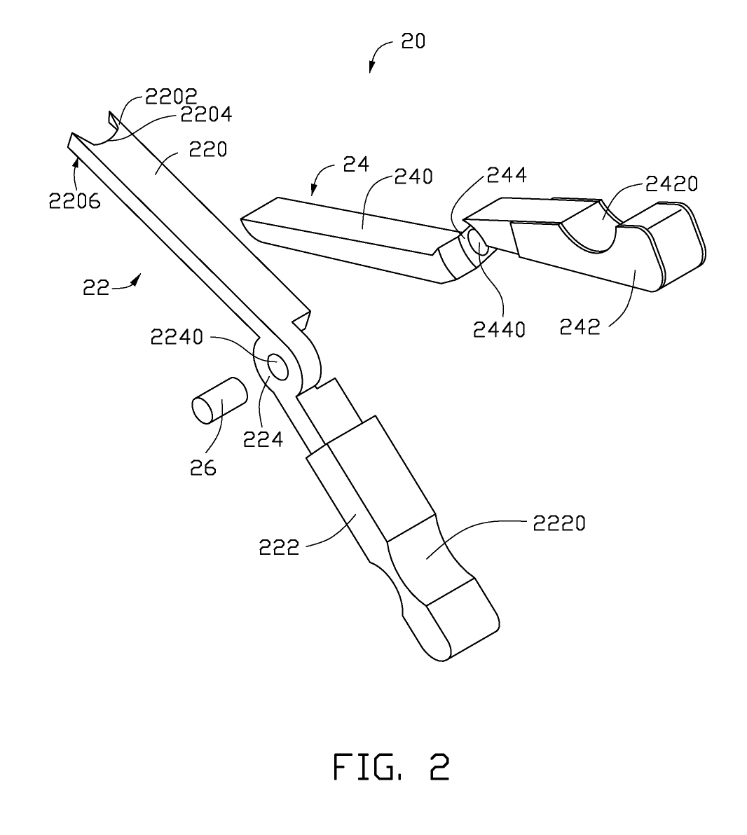

Referring to FIG. 2, a cutting device 20 for cutting the barrel 32 according to a present embodiment is shown. The cutting device 20 is configured for cutting the barrel 32 and then taking the optical components 34 out of the barrel 32. Similar to a scissor, the cutting device 20 includes a first main body 22, a second main body 24 pivotally mounted on the first main body 22, and a pivot pin 26.

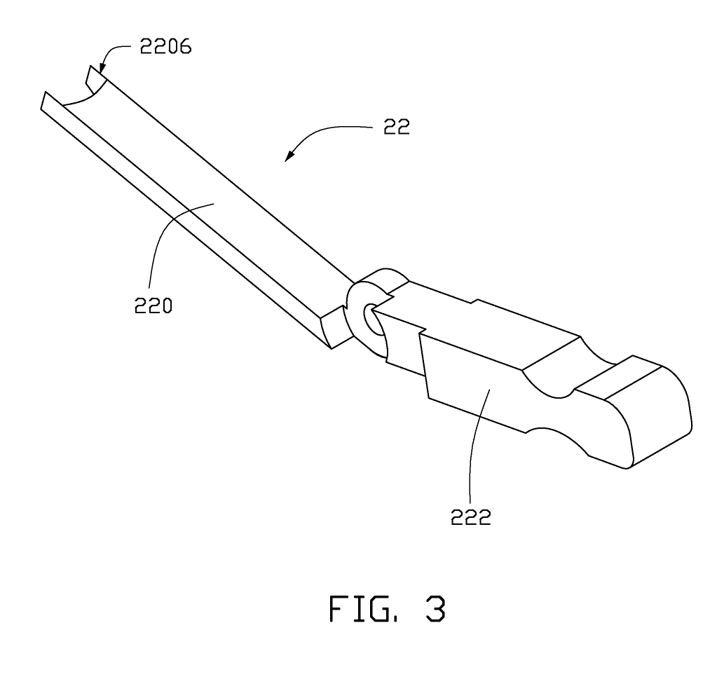

Referring to FIGS. 2 and 3, the first main body 22 includes a cutting portion 220, a first arm 222, and a first pivot portion 224 connecting the cutting portion 220 and the first arm 222. The cutting portion 220 includes two spaced parallel blades 2202 arranged at a distal end thereof away from the first pivot portion 224. The two blades 2202 cooperatively define a gap therebetween. Cutting edges 2206 of the blades 2202 face the second main body 24. A length of the cutting edge 2206 in a lengthwise direction of the blade 2202 is equal to or larger than a radial thickness of the barrel 32. The two blades 2202 are connected by a smooth curved surface 2204 concaved towards the first pivot portion 224. The curved surface 2204 matches with a shape of the barrel 32. The first arm 222 has a first handle 2220 at one end thereof away from the first pivot portion 224. In the present embodiment, the first handle 2220 is a recess structure defined at one end of the first arm 222. The first handle 2220 is configured for a user to hold the cutting device 20, thus facilitating the operation of the cutting device 20. The first pivot portion 224 has a first pivot hole 2240 defined therein.

Referring to FIG. 2 again, the second main body includes a supporting portion 240, a second arm 242, and a second pivot portion 244 connecting the supporting portion 240 and the second arm 242. The supporting portion 240, the second arm 242, and the second pivot portion 244 corresponds to the cutting portion 220, the first arm 222, and the first pivot portion 244 respectively. The second pivot portion 244 has a second pivot hole 2440 defined therein. The second arm 242 has a second handle 2420 at one end thereof away from the second pivot portion 244. In the present embodiment, the second handle 2420 is a recess structure defined at one end of the second arm 242. The second handle 2420 corresponds to the first handle 2220, and is configured for a user to hold the cutting device 20, thus facilitating the operation of the cutting device 20.

The pivot pin 26 extends through the first pivot hole 2240 and the second pivot hole 2440 to pivotally mount the second main body 24 on the first main body 22. Hence, the cutting portion 220 is capable of moving towards or away from the supporting portion 240.

In operation, when the first arm 222 and the second arm 242 are driven to move towards each other by the user, the cutting portion 220 moves towards the supporting portion 240. When the first arm 222 and the second arm 242 are driven to move away from each other by the user, the cutting portion 220 moves away from the supporting portion 240.

In the present embodiment, a length of the cutting portion 220 is less than that of the first arm 222, and a length of the supporting portion 240 is less than that of the second arm 242.

In addition, a method for cutting the barrel 32 using the cutting device 20 is also provided.

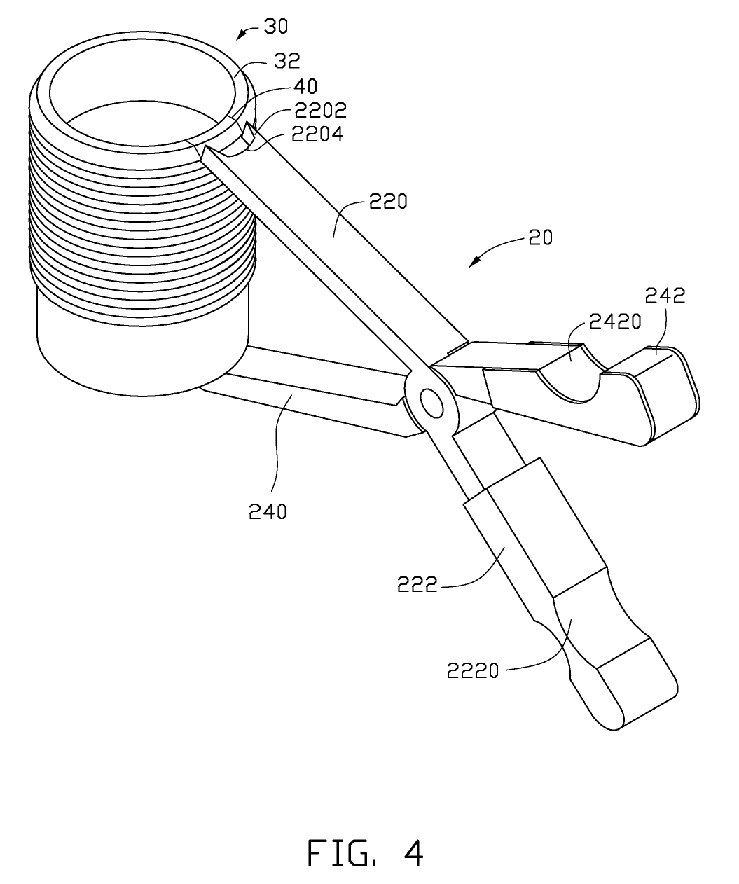

Firstly, referring to FIG. 4, pairs of lines 40 are marked on the outer surface of the barrel 32 using the cutting device 20.

Secondly, the first arm 222 is driven to move away from the second arm 242 so that the cutting portion 220 moves away from the supporting portion 240. Then the lens module 30 is placed between the cutting portion 220 and the supporting portion 240 in such a manner that the one end of the barrel 32 is in contact with the supporting portion 240, an opposite end of the barrel 32 is in touch with the cutting edges 2206, and the cutting edges 2206 align with a pair of lines 40.

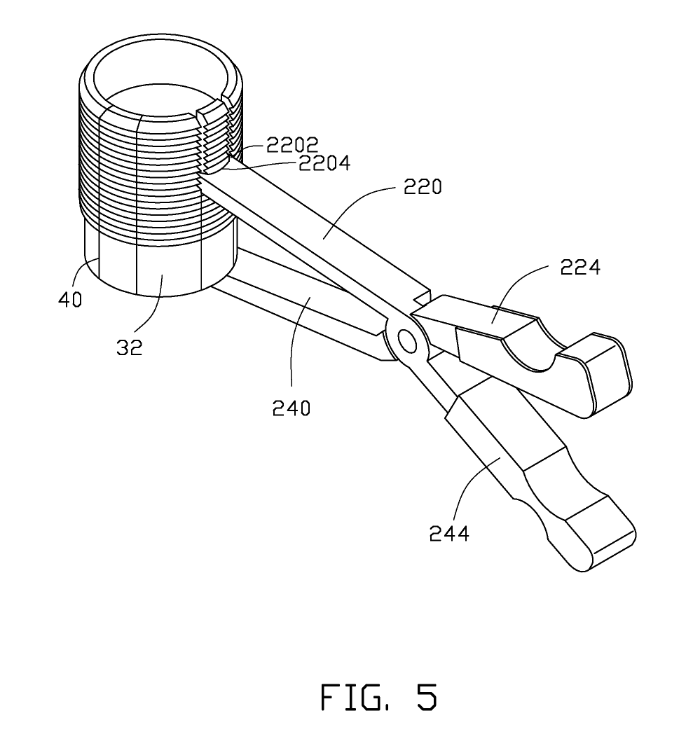

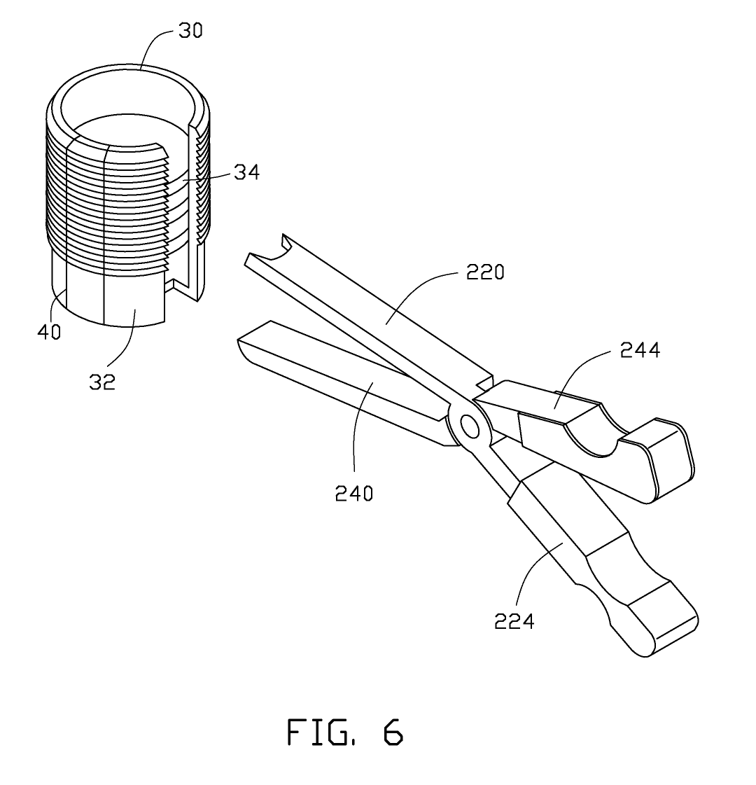

Thirdly, referring to FIG. 5, the first arm 222 is driven to move towards the second arm 242 so that the cutting edges 2206 of the blades 2202 move towards the supporting portion 240. As a result, part of the barrel 32 is cut off from the lens module 30 by the blades 2202, referring to FIG. 6. Accordingly, the optical elements 34 exposed.

By repeating the second and the third steps above, a plurality of adjacent parts of the barrel 32 are cut off from the lens module 30 until the optical elements 34 can be taken out of the barrel 32, as seen in FIG. 7.

Subsequently, the optical elements 34 can be easily taken out of the barrel 32, and then recycled.

In the present embodiment, the cutting device 20 includes a cutting portion 220 and a supporting portion 240. The cutting device 20 can be used to hold the barrel 32 and cut the barrel 32 simultaneously. Accordingly, it is easy to control a cutting direction on the barrel 32. As a result, the to-be-recycled optical elements are not easily damaged, and the operator may avoid being injured. Furthermore, it is convenient to recycle the optical elements, thus decreasing cost of recycling the optical elements.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A cutting device, comprising:
a first main body comprising a cutting portion arranged at one end thereof, the cutting portion comprising two spaced blades disposed at one end thereof, each blade having a cutting edge; and
a second main body pivotally mounted on the first main body, the second main body comprising a supporting portion, the supporting portion facing the cutting edges of the blades, the supporting portion being pivotedly movable towards or away from the blades.

2. The cutting device as claimed in claim 1, wherein the first main body further comprises a first arm arranged at another end thereof away from the cutting portion, and the second main body further comprises a second arm arranged at another end thereof away from the supporting portion.

3. The cutting device as claimed in claim 2, wherein a length of the cutting portion is less than that of the first arm, and a length of the supporting portion is less than that of the second arm.

4. The cutting device as claimed in claim 2, wherein the first arm further has a recess defined therein.

5. The cutting device as claimed in claim 2, wherein the second arm further has a recess defined therein.

6. The cutting device as claimed in claim 2, wherein the first main body further comprises a first pivot portion connected between the cutting portion and the first arm, and the second main body further comprises a second pivot portion connected between the supporting portion and the second arm.

7. The cutting device as claimed in claim 5, further comprising a pivot pin, wherein the first pivot portion further has a first pivot hole defined therein, the second pivot portion further has a second pivot hole defined therein, and the pivot pin extends through the first pivot hole and the second pivot hole so that the second main body is pivotally mounted on the first main body.

8. A cutting device for cutting a barrel, comprising:
a first main body comprising a cutting portion arranged at a first end thereof, a first arm disposed at a second end thereof opposite to the first end, and a first pivot portion connected between the cutting portion and the first arm, the cutting portion comprising two spaced blades disposed at one end thereof, each blade having a cutting edge; and
a second main body comprising a supporting portion arranged at a first end thereof, a second arm disposed at a second end thereof opposite to the second arm, and a second pivot portion connected between the supporting portion and the second arm, the supporting portion facing the cutting edges of the blades, the second pivot portion pivotally mounted on the first pivot portion, the supporting portion being pivotedly movable towards or away from the blades.

9. The cutting device as claimed in claim 8, wherein a length of the cutting portion is less than that of the first arm, and a length of the supporting portion is less than that of the second arm.

10. The cutting device as claimed in claim 8, wherein the first arm further has a recess defined therein.

11. The cutting device as claimed in claim 8, wherein the second arm further has a recess defined therein.

12. The cutting device as claimed in claim 8, further comprising a pivot pin, wherein the first pivot portion further has a first pivot hole defined therein, the second pivot portion further has a second pivot hole defined therein, and the pivot pin extends through the first pivot hole and the second pivot hole so that the second main body is pivotally mounted on the first main body.

13. The cutting device as claimed in claim 8, wherein a length of the cutting edge in a lengthwise direction of the blade is equal to or larger than a radial thickness of the barrel.

14. A pair of scissors comprising:
a first scissor member comprising a first clamping portion and a first handle, two parallel blades formed on the first clamping portion, a gap being defined between the blades; and
a second scissor member pivotedly coupled to the first scissor member, the second scissor member comprising a second clamping portion and a second handle, a clamping surface formed on the second clamping portion facing toward the blades.

15. The scissors as claimed in claim 14, wherein each blade comprises a cutting edge facing the clamping surface.

16. The scissors as claimed in claim 14, wherein a length of the first clamping portion is less than that of the first handle, and a length of the second clamping portion is less than that of the second handle.
